(19) United States
(12) Patent Application Publication
(10) Pub. No.: US 2009/0066836 A1
(43) Pub. Date: Mar. 12, 2009

(54) Front-viewing side mirror camera

(76) Inventor: Kevin Yang, Palos Verdes Estates, CA (US)

Correspondence Address: LAW OFFICES OF CLEMENT CHENG, 17220 NEWHOPE STREET #127, FOUNTAIN VALLEY, CA, 92708, US

(21) Appl. No.: 12/287,603

(22) Filed: Oct. 10, 2008

Related U.S. Application Data
(62) Division of application No. 11/527,154, filed on Sep. 26, 2006.

(51) Int. Cl. H04N 5/225

(52) U.S. Cl. 348/373; 348/E05.024

(57) ABSTRACT

A multi-reflective vehicular mirror is provided. A mirror housing is primarily attached to a passenger side of the vehicle and has a shell facing the front of the vehicle and a cavity facing the rear of the vehicle. The shell has a proximal side mounted on the vehicle and a distal side opposite to the proximal side. A mirror glass is mounted on the housing in the cavity and faces rearward to a vehicle driver and it is made locally reflective leaving an area clear to see-thru visions. The housing shell has a front window area with a transparent lens, which is aligned with the clear area of the mirror glass to provide a clear view through the mirror. Internally of the housing shell an elongated mirror is mounted to form a mirror-in-mirror structure.

This application is a divisional of co-pending application Ser. No. 11/527,154 filed Sep. 26, 2006 entitled front viewing side mirrors.

### BACKGROUND OF THE INVENTION

A. Field of the Invention

The present invention relates to a vehicle mirror assembly. More particularly, the present invention relates to a side mounted mirror for vehicles having a multi-reflective mirror assembly with an optional front view for close precise vehicle maneuvering.

B. Description of the Prior Art

Vehicle side mounted rear view mirrors (“side mirrors”) have been developed to give vehicle operators more field of view of other vehicles or obstacles at the rear lateral sides for safety purposes. The side mirrors are usually on both the left and right sides of the vehicle. The side view mirror is also called the side view mirror because it provides the driver with a view of the side of the vehicle. Generally, the right side of the vehicle can be seen in the right side view mirror and the left side of the vehicle can be seen in the left view mirror. The view of the side of the vehicle is especially useful when backing up into tight spaces, such as when a parallel parking. The view of the rear side part of the vehicle is also very useful for avoiding backing up over children and pets playing on the sidewalk, or for avoiding shopping carts in a crowded parking lot.

Unfortunately, the side rear view mirrors have blind spots. The popular solution of increasing the field of view while reducing the hazardous “blind spot” hiding potential obstacles is to provide the mirror glass with a convexity or curvature over various portions thereof. Therefore, a vehicular mirror may have complex surfaces ranging from flat planes to varying curvatures to reflect about 10 to 40 degrees of field of view depending on the product specifications.

Exemplary prior arts in the field to the applicant's knowledge are U.S. Pat. No. 6,932,483 wherein a convex or concave plane is provided in a vehicular mirror disposed proximate to the vehicle, and U.S. Pat. No. 4,331,382 where side view mirror area farther from the driver is convex to widen the angle of rear vision. Other prior art devices are essentially variations of these two in the common attempts to give greater rear view.

Advanced side view mirrors include mirror glass, its holder, backing plate, motor-power mount attached to the backing plate for the driver's control of the mirror direction, power circuit such as potentiometer, and a fashioned mirror housing for enclosing the entire mirror components and secures them to the vehicle body through a foldable bracket.

Some vehicles take advantage of the on-board computer that interrupts the power mount of the mirror at reversing the vehicle to direct the mirror downward so that the driver can see the curb during parallel parking. The computer then returns the mirror to the previous setting when sensing the shift back to drive. So, the field of view is extended to downward although it is limited to occur in reversing the vehicle.

It is, therefore necessary to provide a completely different approach to the broadening of view of the side view mirror to the frontward direction. In view of the foregoing, an object of the present invention is to provide a vehicular side view mirror having an optional frontward view that is in a seamless continuation of the main rear view in the conventional side mirror housing.

Another object of the present invention is to provide a novel viewing system of a vehicular side view mirror that is contrary to the conventional optical system and newly permitting reflection of frontward images to the driver's vision. Yet another object of the present invention is to provide a non-interfering side, rear and front view mirror that prevents a double vision from being reflected to the driver.

### SUMMARY OF THE INVENTION

A multi-reflective vehicular side mirror of the present invention comprises at least one mirror housing attached to a driver side and/or a passenger side of the vehicle and having a shell facing the front of the vehicle and a cavity facing the rear of the vehicle. The shell has a proximal side mounted on the vehicle and a distal side opposite to the proximal side.

A mirror glass is mounted on the housing in the cavity and faces rearward to a vehicle driver, the mirror glass being locally reflective leaving an area clear to see-thru visions. The mirror glass may be mounted operatively on a powered angular adjustment system.

The housing shell has a front window area, which is aligned with the clear area of the mirror glass to provide a clear view through the mirror

Internally of the housing shell an elongated mirror is mounted to form a mirror-in-mirror structure.

Therefore, the locally reflective mirror glass provides the primary side and rear view while the see-thru glass area and the front view mirror cooperate to provide a residual vision switched between a see-thru front view and a reflected frontward view to the driver depending upon the fore and apt driver positions relative to an adjusted position of the internal mirror.

In a first embodiment of the present invention, the clear area of the mirror glass is located at the distal side of the shell and the internal glass is positioned between the distal edges of the clear area and front window area of the housing shell.

In a second embodiment of the present invention, the clear area of the mirror glass is located at the proximal side of the shell and the front view mirror is positioned between the distal edges of the clear area and front window area.

The housing may be made of clear plastic that is selectively tinted with one or more opaque colors and the front window area of the housing shell is formed by not tinting a desired area for transparency.

Also, the housing may be made of opaque plastic and the front window area of the housing shell is formed by cutting out a desired area and covering the same with a transparent member, which is attached to and lies in flush with the housing shell.

The front view mirror may have a curvature and mounted directly on the housing shell or it may be flat and attached to an adjustable base mounted on the shell.

The reflective area of the mirror glass and the front view mirror have independently adjusted fields of view so that two different singular visions are provided in an alternating manner simply by changing the driver's posture fore or apt to be either in the line of sight for side and rear view or the line of sight for front and downward view relative to a preset mirror position to prevent a double vision from being reflected to the driver.

Embodiments of the invention will now be described by way of example with reference to the accompanying drawings.

### BRIEF DESCRIPTION OF THE DRAWINGS

FIG. 1 is a fragmented top view of a rear and front view mirror according to the preferred embodiment of the present invention.

FIG. 2 is a front view of the rear and front view mirror of FIG. 1 showing a transitional line between the normal rear view and the optional front view.

FIG. 3 is a back view of the rear and front view mirror of FIG. 1 showing a frontward window in flush with the mirror hosing.

FIG. 4 is a schematic view of the opposite lines of sight implemented using the rear and front view mirror of the present invention.

Similar reference numbers denote corresponding features throughout the attached drawings.

### DETAILED DESCRIPTION OF THE PREFERRED EMBODIMENT

With reference to FIG. 1, a multi-reflective side, rear and front view mirror 10 according to an embodiment of the present invention is shown including a mirror housing 11 for holding a mirror glass 12 in its cavity 13. The drawing is schematic wherein housing 11 is shown in direct contact with mirror glass 12 for easier understanding of the invention although the inventive mirror 10 is readily adaptive to the current side view mirror configurations that normally incorporate power adjustment systems but will not interfere with the installation of the mirror 10. The mirror 10 may replace the existing side view mirror assemblies with an extra field of view.

Primarily, a side mirror housing 11 is located far from a driver at a front passenger side either at right or left of the vehicle as specified by the regional traffic regulations. When the mirror 10 is applied to an automobile, side mirror housing 11 will be located behind a front wheel longitudinally of the automobile. Additionally, the symmetrical structure of mirror 10 may be provided when market demands the same benefit of the present invention also at the driver side of the vehicle.

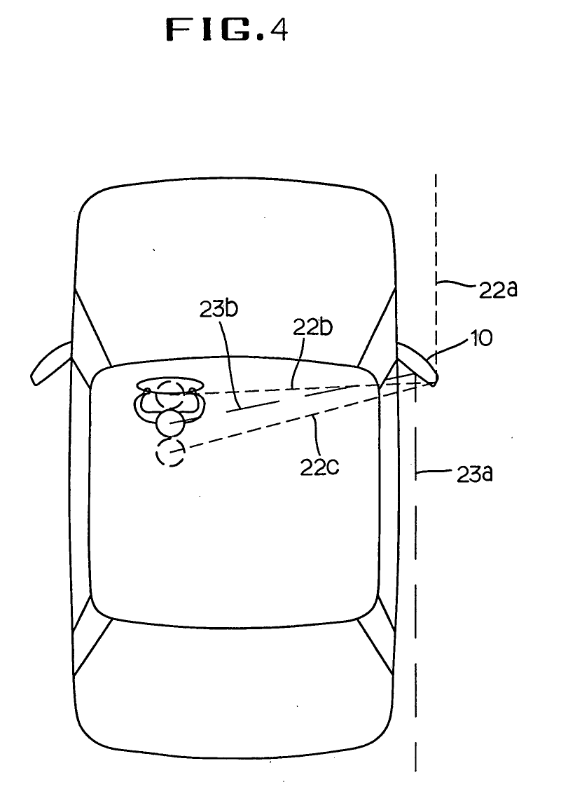

The illustrated housing 11 is attached at its proximal side 14 to the right side of a vehicle (see FIG. 4). Mirror housing 11 may be made of any conventional material such as plastic material. Another material of choice may be a metal. Housing 11 also has a distal side 15 generally positioned rearward relative to the proximal side 14 so that mirror glass 12 faces toward the vehicle driver.

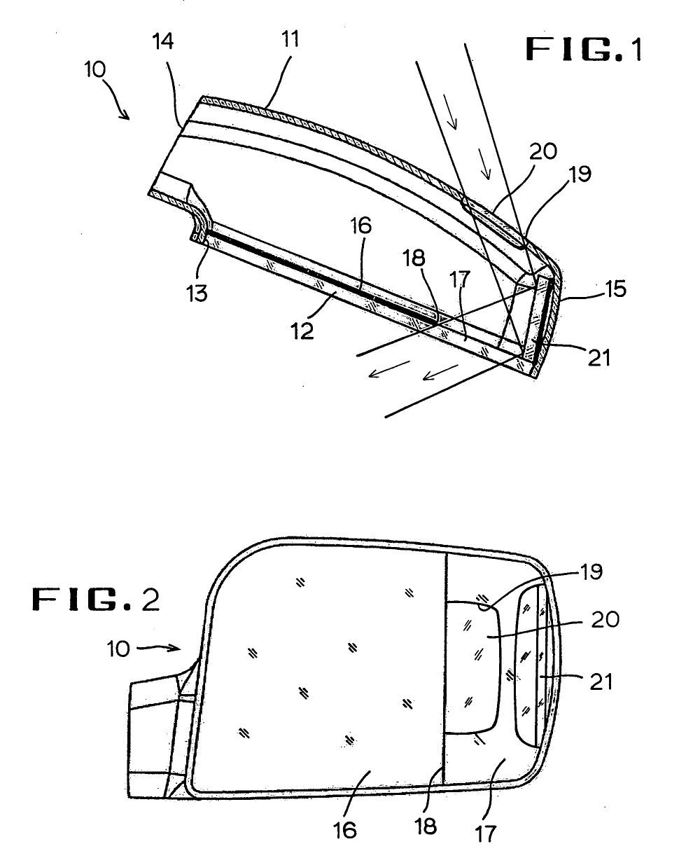

Mirror glass 12 is locally coated according to the present invention so that it has main reflective coating area 16, which stops short of about one third of mirror glass 12 distally. In order to provide an unobstructed see-thru vision, a clear glass section 17 of the glass 12 is free of a silver coating, the method of which is well known in the art and will not be repeated herein. So, to the observer's eyes there is offered an optical transition line 18, clearly depicted in FIG. 2. It is also contemplated in an alternative embodiment of the present invention to invert the position of the transition line 18 so that clear section 17 is disposed proximally to the vehicle.

Side mirror housing 11 also has a front window 19 facing forward of the vehicle and is located near the distal side 15 so that it generally aligns with the distal glass section 17 with respect to the longitudinal axis of the vehicle. If housing 11 is of opaque plastic, front window 19 is provided by a cut-out of the housing walls and then covered by a clear member 20 of glass or acrylic material, which is permanently attached to housing 11 by bonding or welding and lies flush with the surrounding contour of the housing 11. In the alternative embodiment, the front window 19 is located near the proximal side 14 in alignment with the clear section 17.

In addition, clear plastic may be used to form housing 11 and is selectively colored with one or more opaque paints that match the vehicle color leaving the desired area for front window 19 transparent, whereby separate piece 20 is saved from adding.

On the interior walls of housing 11 an elongated mirror 21 is mounted so that it reflects the vision in front of housing 11 and thus the vehicle to the rear next to the main reflective area 16. Illustrated mirror 21 is internally attached to the distal side 15 of housing 11.

Front view mirror 21 may have different curvatures from flat to convex to concave depending on the specifications of the side view mirror to meet or such mirror to replace. However, simply increasing the radius of curvature of convex mirror 21 to gain a wider view will deteriorate the depth perception or the sense of true distance. One way to find a good balance between the optical quality and quantity is to provide mirror 21 with flat or slightly convexed surfaces and mount it adjustably on the distal side 15 of housing 11 through a ball joint. Then, the swivable mirror 21 may be adjusted using any handy leverage devices like a flat blade screwdriver that is inserted into a gap between the inside of the distal side 15 and an opposing side edge of the glass 21 as found in most adjustable side view mirror designs.

However, by providing just enough convexity for a wider field of view swivable mounting for front view mirror 21 may be exempted.

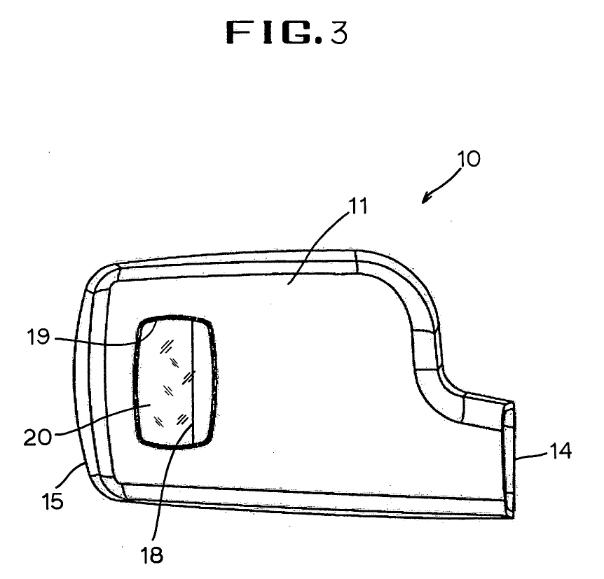

When directly viewed in front or rear of the mirror 10 as FIGS. 2 and 3, the observer can see through clear glass section 17 and clear member 20, i.e. through the mirror 10.

At will, the driver can see what's in front of the vehicle framed by window 19 within housing 11. In addition, the front view mirror 21 obliquely faces the front of the vehicle and provides reflections to the rear and toward the vehicle 11 in the lines of sight 22a/22b or 22a/22c shown in FIG. 4. Since the level of mirror 10 in the driving position is below the eye level of the driver D, The driver is able to clearly observe the reflected images of around the front areas of the vehicle.

This virtual information is valuable during the precision maneuvering of vehicle in a tight space such as in parallel parking to check for any potential collision against other vehicles or to enter a small door garage. Besides the frontward view capacity of the mirror 10, the rear viewing of the same mirror 10 is constantly permitted along its lines of sight 23a and 23b.

Therefore, the locally reflective mirror glass 12 provides the primary side and rear view while the see-thru glass section 17 and front view mirror 21 cooperate to provide a residual vision switched between a see-thru front view and a reflected front and downward view to the driver.

Due to the independent integration of frontward view mirror 21 into the vehicle mirror 10, having two opposite views optically separated to prevent interference is as simple as several initial adjustments of the angular position of front view mirror 21. In operation of the mirror 10, the main reflective area 16 and front view mirror 21 are independently adjusted to the respective best views. With proper adjustments of the two different reflective mirror surfaces, the driver D can choose to have the vehicle rear views only while in a driving posture and switch to the front views by simply changing posture fore or apt to be in the line of sight 22b or 22c depending on the driver's own presetting of mirror 21 position.

Therefore, the driver D is prevented from looking at two oppositely moving visions on physically singular mirror surface of glass 12.

The frontward view of the mirror now provides a front view in areas where the body of the vehicle limits visibility, such as in areas directly in front of the vehicle, or beyond the front vehicle. The front view mirror also could be replaced with a small video camera and monitor. The video camera would be mounted in the forward window portion inside of the side view mirror, and the monitor would be easily installed anywhere inside of the vehicle (as long as it is around the car driver). In this way, the frontward mounted camera with LCD small screen system can completely replace the frontward mirror's configuration. The camera could capture the same image that the forward viewing mirror captures, and the LCD small screen could display the same image that the forward mirror delivers. Although the video camera and LCD small screen system can provide the same function as the front mirror configuration, it would cost much more than the frontward-able side view mirror.

In the camera embodiment, the clear member 20, FIG. 1 is the lens of the camera, and the front window 19 is the camera housing. The camera is a typical flat profile camera. The area of the clear glass section 17 is the same except that it comprises an LCD display or has an LCD display mounted behind it displaying what is captured by the camera.

Therefore, while the presently preferred form of the multi-reflective side, rear and front view mirror has been shown and described, and several modifications thereof discussed, persons skilled in this art will readily appreciate that various additional changes and modifications may be made without departing from the spirit of the invention, as defined and differentiated by the following claims.

1. A front view camera assembly for a vehicle comprising:
a housing attached to a vehicle side;
a rear side view mirror mounted on the housing providing the driver a rear side view;
a front view camera mounted on inside of the housing, wherein the front view camera is positioned to provide the driver a front view.

2. The front view camera assembly of claim 1, wherein the rear side view mirror housing has a reflective section and an optically clear area, wherein the optically clear area cooperates with a front view camera mounted internally inside the housing.

3. The front view camera assembly of claim 2, wherein the housing has a shell facing the front of the vehicle and a cavity facing the rear of the vehicle, wherein the shell has a proximal side mounted on the vehicle and a distal side opposite to the proximal side; wherein the front view camera is mounted on the housing in the cavity.

4. The front view camera assembly of claim 1, wherein the housing has a shell facing the front of the vehicle and a cavity facing the rear of the vehicle, wherein the shell has a proximal side mounted on the vehicle and a distal side opposite to the proximal side; wherein the front view camera is mounted on the housing in the cavity.
